(19) United States
(12) Patent Application Publication
(10) Pub. No.: US 2007/0181510 A1
(43) Pub. Date: Aug. 9, 2007

(54) Algaecidal compositions for water treatment and method of use thereof

(76) Inventors: Michael S. Harvey, Modesto, CA (US); Jonathan N. Howarth, Modesto, CA (US)

Correspondence Address: Audrey A. Millemann;Weintraub Genshlea Chediak, 11th Floor, 400 Capitol Mall, Sacramento, CA, 95814, US

(21) Appl. No.: 11/347,512

(22) Filed: Feb. 3, 2006

(51) Int. Cl. C02F 1/50

(52) U.S. Cl. 210/759; 210/764

(57) ABSTRACT

The invention includes compositions and a method of treating water to reduce algae in bodies of water, including decorative fountains, swimming pools, wastewater lagoons, storage reservoirs, and ornamental lakes and ponds, such as water features on golf courses. The composition includes a blend of two solid peroxygen compounds: sodium percarbonate and either sodium perborate tetrahydrate or sodium perborate monohydrate. An anticaking agent, such as calcium silicate may be added. The method includes administering the blend to the water by a variety of means, such as manual broadcasting ,or placing in a chemical feeding device.

### BACKGROUND OF THE INVENTION

1. Field of the Invention

The invention relates to compositions and methods to treat water to reduce algae, particularly wastewater lagoons, pools, cooling water, lakes, ponds, and reservoirs, including water features on golf courses.

2. Description of the Related Art

Outbreaks of algae plague many outdoor water systems including wastewater lagoons, storage reservoirs, decorative fountains, swimming pools, cooling water, irrigation canals and ornamental lakes, ponds, lagoons, and reservoirs, such as the water features on golf courses. Golf players and the owners of golf courses do not like to see algae infestation in water features because it is unsightly and conveys the impression that the course is poorly maintained. Moreover, a thick mass of green algae floating on the surface of a golf course water feature is easily mistaken for rough ground. It is common for golfers to tread on the algal mass in this mistaken belief, and have their legs or even their entire bodies disappear into the water below. This is clearly humiliating and uncomfortable for the golfer.

Aside from the negative aesthetic effects of colored and turbid water, algae can cause a host of operational problems. For example, an algae-infested wastewater lagoon may fail to meet discharge permits because the level of suspended solids is too high. Algae masses can impede the flow of irrigation canal water and disrupt the water distribution system by clogging canal gate valves, pump intakes, screens, filters, sprinkler heads, irrigation drip tape and emitters. In cooling water, algae can plug water distribution channels, causing uneven water flow through the tower which reduces the cooling efficiency and increases the operational costs. Algae can deprive ornamental lakes of dissolved oxygen by being a food supply for oxygen-consuming bacteria. Absent of oxygen vital to sustain fish and other aquatic fauna, the process of eutrophication (slow death) commences.

In order to combat these types of troublesome algae growth, a host of chemical treatment systems have been developed. These fall into two main categories: algaecides, which are chemical treatments designed to destroy algae blooms, and algaestats, which are designed to prevent the algae from taking a foothold in the first place. Perhaps the most widely used algaecide is copper sulfate, or a chelated form of copper. It is routinely added to irrigation water canals, swimming pools, and ornamental lakes. However, its use is steadily diminishing as departments of natural resources and departments of environmental quality across the United States are closely scrutinizing its environmental impact in soil and water. Copper sulfate can impart an artificial blue tinge to bodies of water to which it is added, and it will stain the gunite surfaces of swimming pools to which it has been introduced.

Bodies of water that are normally halogenated with bromine or chlorine can also suffer from algae infestation. Usually this occurs if the halogen dose is too low or if the delivery was interrupted for some reason. Shock dosing of the halogens is routinely practiced in these circumstances. The water is treated with a single, high dose of the halogen (10-20 times the normal) usually after sunset so that ultra-violet light is not allowed to decompose the chemical. Although this is an effective means of killing algae, it is limited to waters that are normally halogenated so is not amenable to waters that contain fish or plant life.

Quaternary ammonium compounds are another class of chemical with well-known algaecidal properties. Alkyldimethylbenzyl ammonium chloride (ADBAC) compounds were the early generation of this type of product and usually consisted of mixtures of products in which the alkyl group was a C₈-C₁₆ linear carbon chain. The newer generation of quaternary ammonium compounds include the didecyl-, dioctyl-, octyldecyl-, diisononyl-dimethyl ammonium compounds and mixtures thereof which are reported to have algaecidal properties superior to the ADBAC compounds. Quaternary ammonium compounds are commonly introduced to swimming pools, ornamental fountains, and ornamental lakes for algae control, but are rarely used in cooling water because of their tendency to foam, and incompatibility with anionic scale inhibitors. These limitations are diminished with the use of polyquaternary ammonium compounds such as poly(oxyethylene(dimethylimino)ethylene(dimethylimino))ethylene dichloride also known as Water Soluble Cationic Polymer (WSCP) or Busan 77.

Although quaternary and polyquaternary ammonium compounds are widely used algaecides, they are slow-acting and take several days to show effectiveness. For this reason, they are commonly applied in conjunction with a halogen compound or tributlytin oxide for synergistic performance.

Certain aquatic herbicides of the atrazine family (simazine and terbuthylazine) have been applied to water systems for destruction of algae. These materials work by blocking photosynthetic reaction pathways such that the algae perish because they cannot metabolize carbon dioxide into sugar. Again, this is a fairly slow process and it may take one to two weeks for the algae to die. Unfortunately, atrazine herbicides have been shown to be endocrine disrupting chemicals and have been linked to hermaphrodization in frogs exposed to the herbicides. Atrazine compounds are classified as possible human carcinogens because they have been found to cause tumors in rodents. France has banned the use of atrazine herbicides because of these adverse environmental properties.

Peroxygen compounds including hydrogen peroxide, sodium percarbonate, sodium perborate, and potassium monopersulfate have been employed to combat algae when used with a combination of costly non-oxidizing biocides. For example, a commercially available system designed for algae control in swimming pools uses hydrogen peroxide with polyhexamethylene biguanide hydrochloride. Peroxygen compounds used with 2,2-dibromo-3-nitrilopropionamide; methylene bis thiocyanate; 5-chloro-2-methyl-4-isothiazolin-3-one-2-methyl-4-isothiazolin-3-one; tetrahydro-3,5-dimethyl-2H,1,3,5-thiadiazine-2-thione; and sodium dimethyldithiocarbamate/disodium ethylene bis dithiocarbamate have all been reported to be effective against algae.

A stand-alone peroxygen system based on sodium percarbonate has been registered as an algaecide with the United States Environmental Protection Agency. Applying the product at 9-51.9 lb/million gallons of water is claimed to be effective for control of blue-green algae (cyanobacteria) in lakes, ponds and drinking water reservoirs. However, at this dose, the manufacturer notes that green algae are unaffected. Another drawback to the use of this product, is that upon dissolution, sodium carbonate is released into the water according to the following equation:
2Na₂CO₃.3H₂O₂=2Na₂CO₃+3H₂O₂

The sodium carbonate will react with any dissolved calcium in the water to form insoluble calcium carbonate. In natural waters of moderate to high calcium hardness, this is manifest as the development of a chalky cloud in the vicinity of where the sodium percarbonate was applied. This gives the water an unappealing turbid appearance until the calcium carbonate settles to the bottom of the body of water.

It is clear from this description of the related art that there exists a need for an algae remediation and control system that does not suffer the limitations of the existing remediation and control strategies. An ideal system should: (1) be free of transition metals that are of environmental concern; (2) not cause staining and impart an artificial coloration to the treated water; (3) not be toxic to fish and other aquatic wildlife; (4) kill the algae rapidly and not cause the water to foam; (5) not have endocrine disrupting properties or be a possible human carcinogen; (6) not require the use of an expensive non-oxidizing biocide to perform effectively; (7) not cause extensive calcium carbonate precipitation which causes the water to become turbid; and (8) be effective against a broad spectrum of algae. This invention addresses all these needs.

### SUMMARY OF THE INVENTION

This invention fulfills the foregoing needs by providing compositions and methods for eradication and control of algae in bodies of water that turn over slowly, i.e., those with holding time indices of greater than one day, including decorative fountains, swimming pools, wastewater lagoons, storage reservoirs, and ornamental lakes and ponds, such as those encountered on golf courses.

In particular, the invention is directed towards an algaecidal composition that is a blend of solid peroxygen compounds: sodium percarbonate with sodium perborate monohydrate or sodium perborate tetrahydrate. In an embodiment, the composition is manually broadcast directly onto the algae floating in the water to be treated.

The algaecidal blend of sodium percarbonate with sodium perborate monohydrate or sodium perborate tetrahydrate represents an ideal algaecidal composition in that: (1) it is free of transition metals that are of environmental concern; (2) it does not cause staining nor impart an artificial coloration to the treated water; (3) it is not toxic to fish and other aquatic wildlife; (4) it kills the algae rapidly and does not cause the water to foam; (5) it does not have endocrine disrupting properties nor is it a possible human carcinogen; (6) it does not require the use of an expensive non-oxidizing biocide to perform effectively; (7) it does not cause extensive calcium carbonate precipitation which causes the water to become turbid; and (8) it is effective against all the algae it challenged.

### DETAILED DESCRIPTION OF THE INVENTION

### The Composition

The algaecidal composition is a blend of two solid peroxygen compounds: sodium percarbonate (Na₂CO₃.1.5H₂0₂) and sodium perborate tetrahydrate (NaBO₃.4H₂0) or sodium perborate monohydrate (NaBO₃.H₂0). Preferably, for economic reasons, the tetrahydrate is used. The sodium percarbonate that is used is preferably material that has been treated or coated so that it is low dusting and free-flowing.

The two solid peroxygen compounds may be mixed by any suitable means, such as using a ribbon blender, a V-blender or a vertical conical screw blender. The preferred mixing method should allow uniform distribution of the two compounds throughout the blend without either compound separating or segregating from the other. As supplied, the unblended compounds contain free moisture. In the blend, steady loss of this moisture over time can cause the product to “cake” or stick together in large clumps making it difficult to pour the blend out of its packaging. Therefore, a small amount of an anticaking agent such as calcium silicate, iron ammonium citrate, fumed silica, or sodium ferrocyanide decahydrate may also be added to the blend to reduce the tendency for caking.

The solid peroxygen compounds may be blended together in proportions ranging between about 95% sodium percarbonate to sodium perborate tetrahydrate or sodium perborate monohydrate, and about 5% sodium percarbonate to about 95% sodium perborate tetrahydrate or sodium perborate monohydrate. Preferably, the proportion is about 50% sodium percarbonate to sodium perborate tetrahydrate or sodium perborate monohydrate. Even more preferably, the proportion is about 34.8% sodium percarbonate to about 65% sodium perborate tetrahydrate or sodium perborate monohydrate to about 0.2% calcium silicate.

### Method of Use

The compositions of the present invention are used to destroy and control algal growth in bodies of water that turn over slowly, i.e., those with holding time indices of greater than one day, including decorative fountains, swimming pools, wastewater lagoons, storage reservoirs, and ornamental lakes and ponds, such as those encountered on golf courses. The compositions may be administered to the water by a variety of means, such as manual broadcasting or by placing in a chemical feeding device through which the water is pumped and dissolve the compositions.

Manual broadcasting is particularly advantageous because no special electrical equipment is needed. A further advantage of manual feeding is that the compositions can be applied directly in contact with algal masses that are floating on the surface of the water or just under the surface of the water. Typically, during manual broadcasting, a scoop is used to sprinkle the product to the areas where it is needed. Since floating algae tends to accumulate at the edges of the lake, pond, reservoir, or lagoon, the compositions may be applied by manually broadcasting from the water's edge. For larger bodies of water, depending upon the depth, waders or a small boat may be used to assist in delivering the compositions to the areas needed.

The dosage rate depends on the amount of algal growth in the water to be treated. The dosage rate may range from about one lb. of the blend per about 1000 gallons of water to about one lb. of the blend per about 10,000 gallons of water. In general, it has been found that algae-infested ponds may be successfully treated with about one lb. of blend per 2000-4000 gallons of water.

The frequency of treatment also depends on the amount of algal growth in the water to be treated. Depending on conditions such as temperature and exposure to sunlight, certain bodies of water will require more frequent treatment to control the algae. The water should be re-treated whenever the algae starts to re-infest the water.

It has been found that the compositions of the invention are exceptionally effective against algae in these bodies of water. Initially, when the compositions are applied directly to algal masses floating on or close to the water's surface, the hydrogen peroxide that is released from both compounds is the biocidal agent that attacks the algae by rapidly turning it gray. On performing biocidal action, hydrogen peroxide gives up oxygen in microscopic bubbles that develop around the algae. The effervescent action of the bubbles disrupt the algae such that large clumps often break free from the main mass that then sink to the bottom of the pond within a few days of treatment.

### EXAMPLES

### Example 1

During the summer season, a 400,000 gallon golf course pond was heavily infested with 6-8 inches of algae which were concentrated around the edges. A blend of 50% sodium percarbonate to 50% sodium perborate tetrahydrate was applied by manually broadcasting 140 lbs. using a scoop, corresponding to a dosage rate of one lb. for every 2,850 gallons of water. The algae immediately started to turn gray. Two days later, approximately one-half of the algae had dropped to the bottom of the pond, and one week later, all of the algae had dropped to the bottom. The water clarity was much improved. The pond remained algae-free for approximately six weeks, when there was evidence that the algae was returning. The pond was retreated with 70 lbs of the blend of 50% sodium percarbonate for 50% sodium perborate tetrahydrate. Again, the algae immediately started turning gray. Four days later, some algae remained, so the pond was treated with another 70 lbs. of the blend and then re-treated with another 140 lbs. of the blend. Approximately one week later, all the algae was gone, and the water clarity was the best the golf course owner had ever seen. Another 140 lbs. of the blend was applied three weeks later. and the pond was restored to its former pristine quality. The pond remained crystal clear for the rest of the year.

### Example 2

In mid-summer, a 340,000 gallon golf course pond was heavily infested with an algae mat. A blend of 50% sodium percarbonate to 50% sodium perborate tetrahydrate was applied by manually broadcasting 170 lbs using a scoop, corresponding to a dosage rate of one lb. for every 2,000 gallons of water. The algae immediately turned gray. Within about three days, most of the gray algae had sunk to the bottom of the pond and no new algae had developed. Within about four more days, all of the algae was deemed to have been eradicated, and the water clarity was much improved. The pond remained crystal clear for about four weeks, the last time that year that the pond was visited.

### Example 3

In mid-summer, a 440,000 gallon golf course pond was 35% covered with a thick algae mat. A blend of 50% sodium percarbonate to 50% sodium perborate tetrahydrate was applied by manually broadcasting 210 lbs using a scoop, corresponding to a dosage rate of one lb for every 2,100 gallons of water. The algae immediately turned gray Within about four days, there was no sign of any live algae, but after about six more days, there were still some dead algae that had not sunk to the bottom of the pond, so it was manually skimmed from the surface. By about two weeks later, the algae was starting to recolonize the pond, so an additional 210 lbs of product was administered. Upon weekly inspections, the pond remained clear and free of algae. Most of the gray algae had sunk to the bottom of the pond and no new fresh algal infestation had developed. The pond remained crystal clear for the rest of the year.

### Example 4

In mid-summer, a 300,000 gallon golf course pond was 75% covered with a thick algae mat. A blend of 50% sodium percarbonate to 50% sodium perborate tetrahydrate was applied by manually broadcasting 140 lbs using a scoop, corresponding to a dosage rate of one lb. for every 2,150 gallons of water. The algae immediately turned gray. However, by about 11 days later, the algae had not dropped to the bottom as with other ponds, possibly due to the shallowness of the pond and the presence of plant growth holding up the algae and preventing it from sinking. Five days later, the floating dead algae was still gray and there was no sign of any new or green algae in the pond. This remained the case for another 11 days. Ten days later, the pond was drained for manual cleaning.

### Example 5

In mid-summer a 210,000 gallon golf course pond was heavily infested with an algae mat. A blend of 50% sodium percarbonate to 50% sodium perborate tetrahydrate was applied by manually broadcasting 105 lbs using a scoop, corresponding to a dosage rate of one lb. for every 2,000 gallons of water. The algae immediately turned gray. The pond was revisited five days later and it was observed that all the algae had been eradicated and the water was crystal clear. About three weeks later, there was still no algae and the pond was as clear as it was in the winter.

The invention has been described above with the reference to the preferred embodiments. Those skilled in the art may envision other embodiments and variations of the invention that fall within the scope of the claims.

We claim:

1. An algaecidal composition, comprising a blend of a first solid peroxygen compound and a second solid peroxygen compound.

2. The composition of claim 1, wherein said first peroxygen compound is sodium percarbonate and said second peroxygen compound is selected from the group consisting of sodium perborate monohydrate and sodium perborate tetrahydrate.

3. The composition of claim 1, wherein said composition includes an anticaking agent.

4. The composition of claim 3, wherein said anticaking agent is calcium silicate.

5. The composition of claim 4, wherein the proportion of said first peroxygen compound to said second peroxygen compound to said calcium silicate is about 34.8% to about 65% to about 0.2%.

6. The composition of claim 2, wherein the proportion of said first peroxygen compound to said second peroxygen compound is between about 95% to about 5% and about 5% to about 95%.

7. A method of treating water to reduce algal growth, comprising:
Administering an algaecidal composition to the water to be treated,
Wherein said composition comprises a blend of a first solid peroxygen compound and a second solid peroxygen compound.

8. The method of claim 9, wherein the dosage rate is between about one lb. per about 1000 gallons of water and about one lb. per about 10,000 gallons of water.
